(19) United States
(12) Patent Application Publication
(10) Pub. No.: US 2019/0335150 A1
(43) Pub. Date: Oct. 31, 2019

(54) SYSTEMS AND METHODS FOR COLOR BALANCING

(71) Applicant: QUALCOMM Incorporated, San Diego, CA (US)

(72) Inventor: Mooyoung Shin, San Diego, CA (US)

(21) Appl. No.: 15/963,897

(22) Filed: Apr. 26, 2018

(51) Int. Cl. H04N 9/73; H04N 5/14; G06T 7/246; G06T 7/90

(52) U.S. Cl. CPC H04N 9/735; G06T 7/90; G06T 7/248; H04N 5/144

(57) ABSTRACT

Aspects of the present disclosure relate to systems and methods for color balancing an image. An example device may include one or more processors and a memory. The memory may include instructions that, when executed by the one or more processors, cause the device to determine that a threshold portion of a first image is a single color, estimate a color temperature for a second image in response to determining that the threshold portion of the first image is the single color, determine, based on the color temperature, a color balance for the first image, and process the first image to generate a final image using the determined color balance.

### TECHNICAL FIELD

This disclosure relates generally to systems for image capture devices, and specifically to color balancing an image.

### BACKGROUND OF RELATED ART

The lighting of a scene may affect the colors in a captured image. For example, fluorescent lighting may cause a blue or cool cast in an image, and incandescent lighting may cause a yellow or warm cast in an image. As a result, an image may include tinting. Tinting is where the image colors are skewed toward a specific color. For example, blue tinting is where all colors are skewed towards a blue color.

A device may use color balancing to compensate for lighting temperature effects (such as tinting) in a captured image. A color balance setting may attempt to determine a difference between the observed color and the estimated color for a portion of an image to adjust all color values in the captured image. For example, a device may determine a white balance setting that is used to remove tinting (such as a blue, red, or green tint) from neutral colors (such as grays and whites) in a captured image, and the white balance setting is applied to the entire image.

Some scenes may cause inaccuracies in conventional color balancing so that the image is still tinted or otherwise affected by the lighting. For example, if a majority of a scene is one color, the estimation of the color may be incorrect and therefore result in an incorrect color balance for the resulting image. As a result, the final processed image may still include a tinting that is not corrected through color balancing.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Aspects of the present disclosure relate to systems and methods for color balancing an image. In some example implementations, a device may include one or more processors and a memory. The memory may include instructions that, when executed by the one or more processors, cause the device to determine that a threshold portion of a first image is a single color, estimate a color temperature for a second image in response to determining that the threshold portion of the first image is the single color, determine, based on the color temperature, a color balance for the first image, and process the first image to generate a final image using the determined color balance.

In another example, a method is disclosed. The example method includes determining that a threshold portion of a first image is a single color, estimating a color temperature for a second image in response to determining that the threshold portion of the first image is the single color, determining, based on the color temperature, a color balance for the first image, and processing the first image to generate a final image using the determined color balance.

In a further example, a non-transitory computer-readable medium is disclosed. The non-transitory computer-readable medium may store instructions that, when executed by a processor, cause a device to perform operations including determining that a threshold portion of a first image is a single color, estimating a color temperature for a second image in response to determining that the threshold portion of the first image is the single color, determining, based on the color temperature, a color balance for the first image, and processing the first image to generate a final image using the determined color balance.

In another example, a device is disclosed. The device includes means for determining that a threshold portion of a first image is a single color, means for estimating a color temperature for a second image in response to determining that the threshold portion of the first image is the single color, means for determining, based on the color temperature, a color balance for the first image, and means for processing the first image to generate a final image using the determined color balance.

### BRIEF DESCRIPTION OF THE DRAWINGS

Aspects of the present disclosure are illustrated by way of example, and not by way of limitation, in the figures of the accompanying drawings and in which like reference numerals refer to similar elements.

FIG. 1A is a depiction of an example processed image.

FIG. 1B is a depiction of another example processed image.

FIG. 2 is a block diagram of an example device for color balancing.

FIG. 3 is an illustrative flow chart depicting an example operation for color balancing.

FIG. 4 is a depiction for determining if a threshold portion of an image is a single color and for determining a color temperature for an image.

FIG. 5 is an illustrative flow chart depicting an example operation for determining when to use another image for color balancing an image.

FIG. 6 is a depiction of an example image from a front facing camera for the example processed image in FIG. 1A captured by a rear facing camera.

FIG. 7 is a depiction of an example reference image for the example image in FIG. 6.

FIG. 8 is an illustrative flow chart depicting an example operation for excluding one or more portions of an image before determining a color temperature for the image.

FIG. 9 is a depiction of the example reference image in FIG. 7 and the example image in FIG. 6 divided into a plurality of portions.

FIG. 10 is a depiction of the example image and the example reference image divided into portions in FIG. 9 with corresponding portions between the example images.

FIG. 11 is an illustrative flow chart depicting an example operation for determining a motion vector for a portion of an image.

FIG. 12 is a depiction of the example reference image and the example image divided into portions in FIG. 9 in determining a corresponding region between the images.

FIG. 13 is a depiction of the example image in FIG. 6 with determined motion vectors illustrated for each portion of the image.

FIG. 14 is a depiction of the example image in FIG. 6 with portions of the image excluded from being used in determining a color temperature.

### DETAILED DESCRIPTION

Aspects of the present disclosure may be used for color balancing an image. A device may determine or estimate a color temperature for a first image. A color temperature may indicate a dominant color tone for the image. The true color temperature for a scene is the color of the light sources for the scene. If the light is radiation emitted from a perfect blackbody radiator (theoretically ideal for all electromagnetic wavelengths) at a particular color temperature (represented in Kelvin (K)), and the color temperatures are known, then the color temperature for the scene is known. For example, in a Commission Internationale de l'éclairage (CIE) defined color space (from 1931), the chromaticity of radiation from a blackbody radiator with temperatures from 1,000 to 20,000 K is the Planckian locus. Colors on the Planckian locus from approximately 2,000 K to 20,000 K are considered white, with 2,000 K being a warm or reddish white and 20,000 K being a cool or bluish white. Many incandescent light sources include a Planckian radiator (tungsten wire or another filament to glow) that emits a warm white light with a color temperature of approximately 2,400 to 3,100 K.

However, other light sources, such as fluorescent lights, discharge lamps, or light emitting diodes (LEDs), are not perfect blackbody radiators whose radiation falls along the Planckian locus. For example, an LED or a neon sign emit light through electroluminescence, and the color of the light does not follow the Planckian locus. The color temperature determined for such light sources may be a correlated color temperature (CCT). The CCT is the estimated color temperature for light sources whose colors do not fall exactly on the Planckian locus. For example, the CCT of a light source is the blackbody color temperature that is closest to the radiation of the light source. CCT is also denoted in K.

CCT may be an approximation of the true color temperature. For example, the CCT may be a simplified color metric of chromaticity coordinates in the CIE 1931 color space. Many devices may use automatic white balance (AWB) to estimate a CCT for color balancing. While color temperature may be described below regarding CCT, any measurement of color temperature may be used (such as in a CIE 1931 color space, along a Planckian locus, etc.) and the present disclosure should not be limited to determining a CCT.

The CCT may be a temperature ranging from warm colors (such as yellows and reds below 3200 K) to cool colors (such as blue above 4000 K). The CCT (or other color temperature) may indicate the tinting that will appear in an image captured using such light sources. For example, a CCT of 2700 K may indicate a red tinting, and a CCT of 5000 K may indicate a blue tinting.

Different lighting sources or ambient lighting may illuminate a scene, and the color temperatures are unknown to the device to capture and color balance an image to reduce tinting caused by the light sources. As a result, the device may analyze data captured by the camera sensor to estimate a color temperature for an image. For example, the color temperature may be an estimation of the overall CCT of the light sources for the scene in the image. The data captured by the camera sensor used to estimate the color temperature for an image may be the captured image itself. The device may also receive a user input or other indication of the color temperature of the light sources that may exist for the scene. For example, the device may be placed into an indoor mode to indicate incandescent light may be lighting the scene, or the device may be placed into an outdoor mode to indicate that direct sunlight may be lighting the scene.

After the device determines a color temperature for the scene (such as during performance of AWB), the device uses the color temperature to determine a color balance for correcting any tinting in the image. For example, if the color temperature indicates that an image includes a red tinting, a device may decrease the red value or increase the blue value for each pixel of the image, e.g., in an RGB space. The color balance may be the color correction (such as the values to reduce the red values or increase the blue values).

The reflections of light from an object that is one color in a scene on its own may be insufficient to accurately estimate or determine a color temperature for an image. However, the accuracy of the color temperature estimation may increase as the variety in object and colors in the image increases. The device may use the measured colors from the different objects and variations to determine an overall color temperature or CCT for the image.

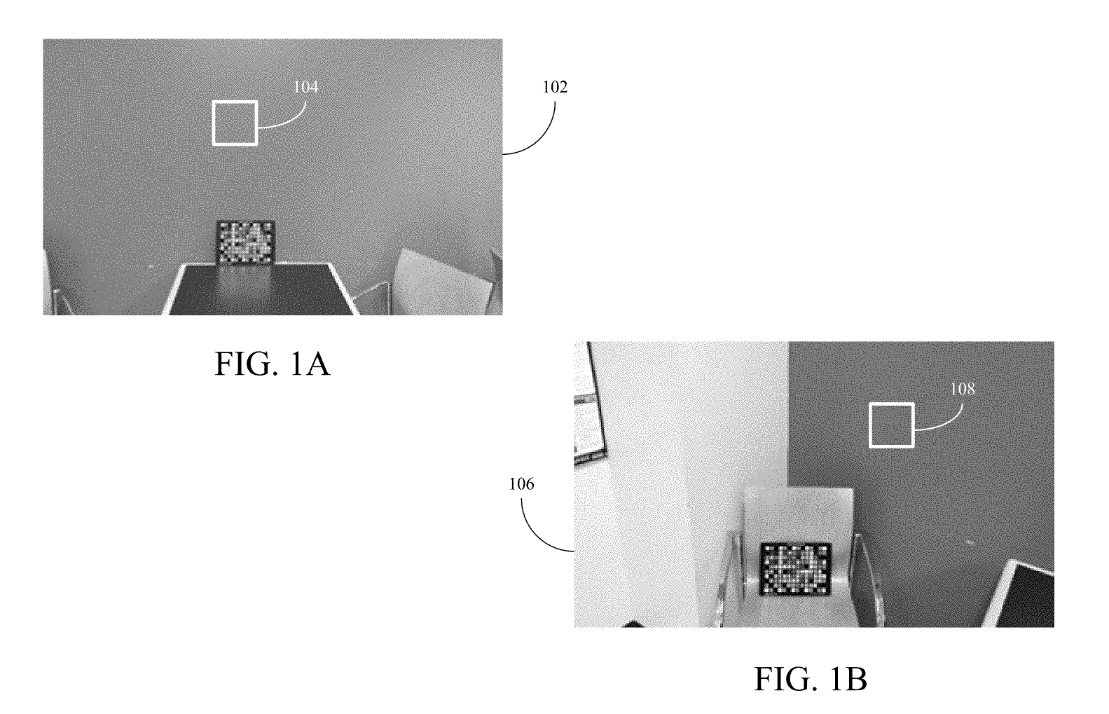

If a large portion of an image (such as a majority of the image or a portion greater than a threshold) is one color, the color temperature estimation may be skewed by the predominant color in the image. FIG. 1A depicts an example processed image 102 after color balancing where a large portion (the wall) is one color.

In some example implementations, a red color to green color ratio (R/G) may indicate whether a red tinting exists and the magnitude of the red tinting that may exist in an image. For example, the R/G for a portion of an image may be depicted by equation (1) below:

$$R / G = \frac{{\sum }_{n = 1}^{N} Red ( n )}{{\sum }_{n = 1}^{N} Green ( n )} \qquad ( 1 )$$

where the portion includes pixels 1-N, each pixel n includes a red value Red(n), a blue value Blue(n), and a green value Green(n) in an RGB space. For example, each red, green and blue value may be from 0-255, and the R/G is the sum of the red values for the pixels in the portion divided by the sum of the green values for the pixels in the portion. Similarly, the B/G for the portion of the image may be depicted by equation (2) below:

$$B / G = \frac{{\sum }_{n = 1}^{N} Blue ( n )}{{\sum }_{n = 1}^{N} Green ( n )} \qquad ( 2 )$$

In some other example implementations, a different color space may be used, such as Y′UV, with chrominance values UV indicating the color, and/or other indications of a tinting or other color temperature effect for an image may be determined.

For the portion 104, the average red to green ratio (R/G) across the pixels may be approximately 1.60 while the average blue to green ratio (B/G) across the same pixels may be approximately 0.44, and the resulting color temperature for the processed image may be 2771 K.

In contrast, FIG. 1B depicts an example processed image 106 including the same wall as in processed image 102. Less of the wall appears in image 106 than in image 102. Further, the color of the wall in the example image 106 is considered to be the ground truth. For the portion 108, the average R/G is approximately 2.07 and the average B/G is approximately 0.26, and the resulting color temperature for the processed image is 3087 K.

Since the majority of the image 102 in FIG. 1A is one color, and the one color skews towards red instead of blue (the wall is a dark orange to red color), a device estimating the color temperature may assume that a red tinting occurs in the image and therefore may attempt to reduce such tinting. As a result, the red in the image may be reduced, as shown by the R/G of 1.60 for the processed image 102 compared to the R/G of 2.07 for the image 106 including the ground truth for the wall's color. A comparison of the B/G between the images 102 and 106 (0.44 versus 0.26, respectively) also shows the skew caused by a majority of the image 102 being one color. In visually comparing the processed image 102 to the image 106, the portion 104 is a lighter shade than the portion 108, further indicating that the color balancing performed for the processed image 102 is not accurate.

In some example implementations, a device may use a different image to estimate or determine a color temperature (such as a CCT) to be used for color balancing an image where a large portion of the image is one color. For example, a second camera may capture a second image, and a color temperature for the second image may be estimated or determined. The determined color temperature may then be used to determine a color balance for a first image captured by a first camera where a large portion of the image is one color. In this manner, color temperature effects may be reduced or removed without being impacted by a predominant color in the scene.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure. Some portions of the detailed descriptions which follow are presented in terms of procedures, logic blocks, processing and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory and the like.

Aspects of the present disclosure are applicable to any suitable electronic device (such as a security system with one or more cameras, smartphones, tablets, laptop computers, digital video and/or still cameras, web cameras, and so on) configured to or capable of capturing images or video. While described below with respect to a device having or coupled to two cameras, aspects of the present disclosure are applicable to devices having any number of cameras (including no cameras, where a separate device is used for capturing images or video which are provided to the device, or one camera for capturing multiple images), and are therefore not limited to devices having two or more cameras. Aspects of the present disclosure are applicable for capturing still images as well as for capturing video, and may be implemented in devices having or coupled to cameras of different capabilities (such as a video camera or a still image camera).

The term “device” is not limited to one or a specific number of physical objects (such as one smartphone, one camera controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects.

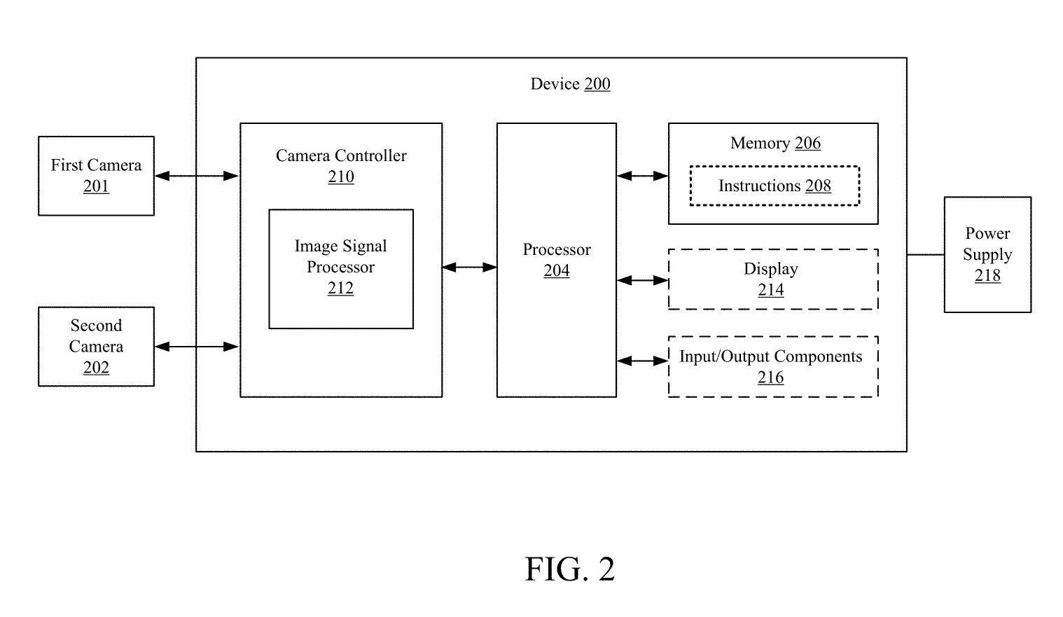

FIG. 2 is a block diagram of an example device 200 for performing color balancing on an image. The example device 200 may include or be coupled to a first camera 201, a second camera 202, a processor 204, a memory 206 storing instructions 208, and a camera controller 210. The device 200 may optionally include (or be coupled to) a display 214 and a number of input/output (I/O) components 216. The device 200 may include additional features or components not shown. For example, a wireless interface, which may include a number of transceivers and a baseband processor, may be included for a wireless communication device. The device 200 may include or be coupled to additional cameras other than the first camera 201 and the second camera 202. Alternatively, the device 200 may include or be coupled to one camera. The disclosure should not be limited to any specific examples or illustrations, including the example device 200.

The first camera 201 and the second camera 202 may be capable of capturing individual image frames (such as still images) and/or capturing video (such as a succession of captured image frames). Each camera may include a single camera sensor, or be a dual camera module or any other suitable module with multiple camera sensors, with one or more sensors being used for capturing images. The first camera 201 may have a different direction and/or field of view than the second camera 202. For example, the first camera 201 may be a rear facing camera of the device 200, and the second camera 202 may be a front facing camera of the device 200. The memory 206 may be a non-transient or non-transitory computer readable medium storing computer-executable instructions 208 to perform all or a portion of one or more operations described in this disclosure. The device 200 may also include a power supply 218, which may be coupled to or integrated into the device 200.

The processor 204 may be one or more suitable processors capable of executing scripts or instructions of one or more software programs (such as instructions 208) stored within the memory 206. In some aspects, the processor 204 may be one or more general purpose processors that execute instructions 208 to cause the device 200 to perform any number of functions or operations. In additional or alternative aspects, the processor 204 may include integrated circuits or other hardware to perform functions or operations without the use of software. While shown to be coupled to each other via the processor 204 in the example of FIG. 2, the processor 204, the memory 206, the camera controller 210, the optional display 214, and the optional I/O components 216 may be coupled to one another in various arrangements. For example, the processor 204, the memory 206, the camera controller 210, the optional display 214, and/or the optional I/O components 216 may be coupled to each other via one or more local buses (not shown for simplicity).

The display 214 may be any suitable display or screen allowing for user interaction and/or to present items (such as captured images, video, or a preview image) for viewing by a user. In some aspects, the display 214 may be a touch-sensitive display. The I/O components 216 may be or include any suitable mechanism, interface, or device to receive input (such as commands) from the user and to provide output to the user. For example, the I/O components 216 may include (but are not limited to) a graphical user interface, keyboard, mouse, microphone and speakers, and so on. The display 214 and/or the I/O components 216 may provide a preview image to a user and/or receive a user input for adjusting one or more settings of the first camera 201 and the second camera 202.

The camera controller 210 may include an image signal processor 212, which may be one or more image signal processors to process captured image frames or video provided by the first camera 201 and the second camera 202. For example, the camera controller 210 (such as the image signal processor 212) may perform color balancing for images received from the first camera 201 and/or the second camera 202. In some example implementations, the camera controller 210 (such as the image signal processor 212) may also control operation of the first camera 201 and the second camera 202. In some aspects, the image signal processor 212 may execute instructions from a memory (such as instructions 208 from the memory 206 or instructions stored in a separate memory coupled to the image signal processor 212) to process image frames or video captured by the first camera 201 and the second camera 202. In other aspects, the image signal processor 212 may include specific hardware to process image frames or video captured by the first camera 201 and the second camera 202. The image signal processor 212 may alternatively or additionally include a combination of specific hardware and the ability to execute software instructions. The image signal processor 212 may perform color balancing. Additionally or alternatively, the processor 204 may perform color balancing.

A determined or estimated color temperature for an image may be inaccurate or insufficient to be used for color balancing the image. In this manner, a color temperature estimated for another image may be used in color balancing the image.

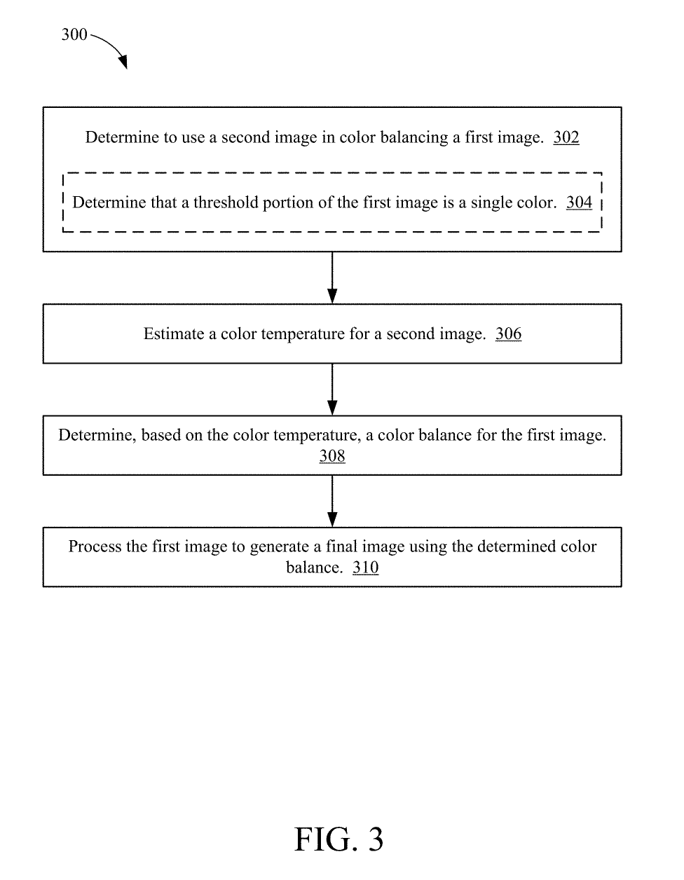

FIG. 3 is an illustrative flow chart depicting an example operation 300 for color balancing. The following example operations (including example operation 300) are described regarding device 200 in FIG. 2 for illustrative purposes. Other devices or configurations may be used, and the present disclosure should not be limited to device 200 or a specific configuration for performing the example operations.

Beginning at 302, the device 200 may determine to use a second image in color balancing a first image (302). In some example implementations, the device 200 may determine that the measured colors in or the color temperature for the first image may be inaccurate or may lead to an erroneous color balancing of the first image. For example, the device 200 may determine that a threshold portion of the first image is a single color (304).

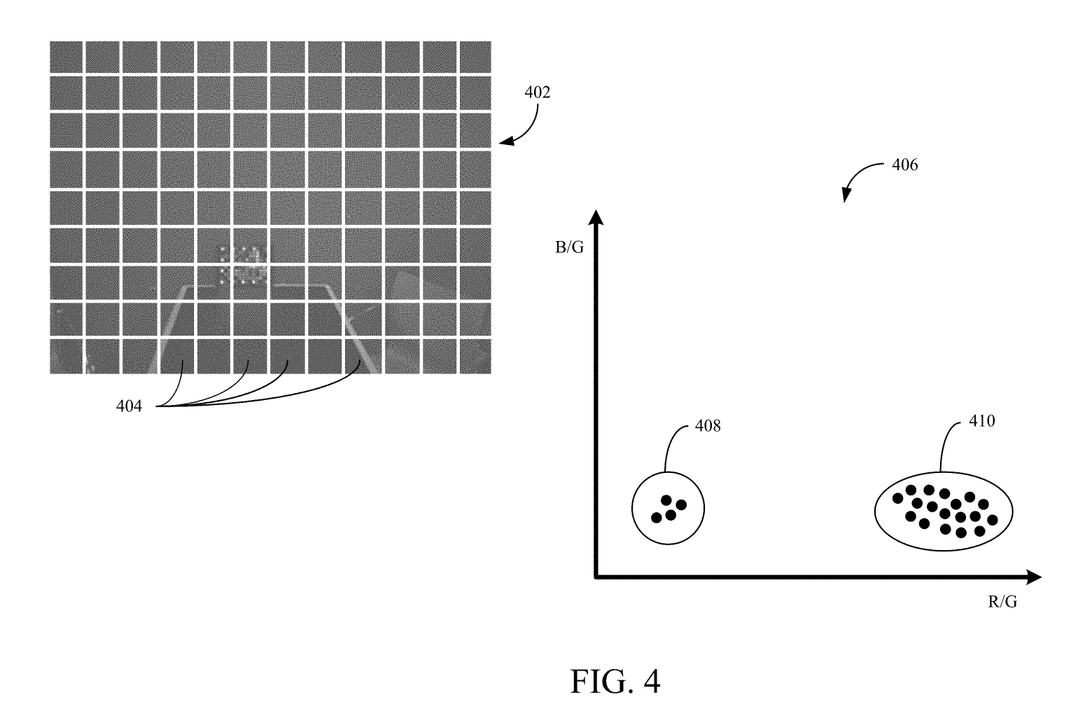

FIG. 4 is a depiction for determining if a threshold portion of an image is a single color and for determining a color temperature for an image (such as during AWB). The image 402 is a depiction of the raw image for the processed image 102 in FIG. 1A. The image 402 is divided into portions 404. The R/G and the B/G may be calculated for each portion. Graph 406 depicts an example distribution of the R/G versus the B/G for the portions 404 of the image 402. The example cluster 408 of a few points may be for the portions 404 of the image 402 including the table. The example cluster 410 of points may be for the portions 404 of the image 402 including the wall.

To illustrate a threshold portion of an image being one color skewing a color temperature of an image, for the image 402 (corresponding to the image 102 in FIG. 1A), a large portion of the scene is one color, and the scene in the processed image 102 (FIG. 1A) and the processed image 106 (FIG. 1B) is illuminated by fluorescent lighting with a color temperature of approximately 4100 K. Incandescent lighting (such as having a color temperature of 2400 K) may cause measurements for portions of the image to be located in the graph 406 near cluster 410. Fluorescent lighting (such as having a color temperature of 4100 K) may cause measurements for portions of the image to be located in the graph 406 towards the B/G axis instead of the R/G axis.

Since the cluster 410 may indicate that the lighting is incandescent (even though the lighting is fluorescent), the CCT of the processed image 102 in FIG. 1A is skewed, with the resulting CCT of the processed image 102 in FIG. 1A being 2771 K and the resulting CCT of the processed image 106 in FIG. 1B being 3087 K. The wall (which is in a majority of the image 402) being a single color causes the device processing the raw or captured image 402 into processed image 102 to determine an erroneous color temperature for the image and skew the color temperature of a processed image toward incandescent lighting instead of fluorescent lighting based on the erroneous color temperature. For example, with the wall being a dark reddish orange, the device 200 may determine that the lighting is more likely incandescent than fluorescent, and therefore skew the color temperature down for an image 402. As a result, a device using the clustering of the R/G versus B/G measurements to determine a color temperature for portions of the image may estimate an erroneous color temperature when a threshold portion of the image is one color.

In some example implementations of determining that a portion of an image is a single color, the device 200 may determine the number of pixels in the image having a color that is within a defined range of colors. For example, the device 200 may determine a number of pixels with red, green, and blue colors in a RGB space within a threshold Euclidian distance from colors for other pixels (such as a threshold root-mean-square value). In some other example implementations, the device 200 may compare the R/G and the B/G for portions of the image to determine if a number of portions with similar R/G and/or B/G is greater than a threshold. For example, referring back to FIG. 4, the device 200 may determine that a number of points within a defined range (such as cluster 410) is greater than a threshold (with each point corresponding to a portion 404). Other ways to determine whether a threshold portion of an image is a single color may be used, and the present disclosure should not be limited to the provided examples. Further, the portion may be contiguous or non-contiguous, and the present disclosure should not be limited to a specific portion type.

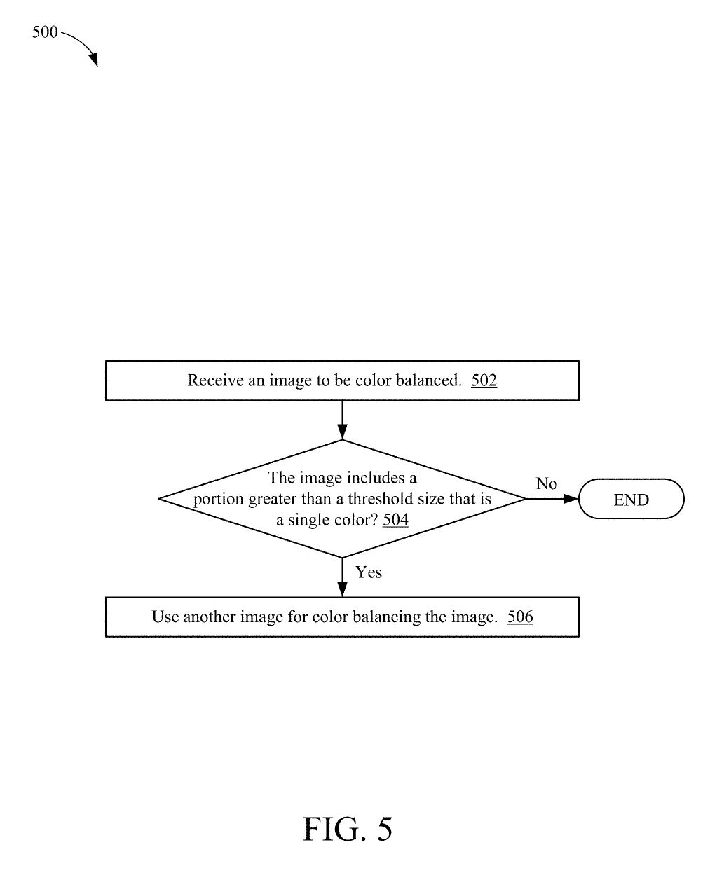

FIG. 5 is an illustrative flow chart depicting an example operation 500 for determining when to use another image for color balancing an image. Beginning at 502, a device 200 may receive an image to be color balanced (such as a raw image or other captured image to be processed). If the image includes a portion greater than a threshold size that is a single color (504), the device 200 may use another image for color balancing the image (506). If the image does not include a portion greater than a threshold size that is a single color (504), the process ends. For example, the device 200 may use the image itself for color balancing (such as determining a color temperature for the image and using the color temperature to determine a color balance for the image). In some example implementations, the threshold may be defined by a manufacturer, user defined, and/or adjustable based on an indicated lighting or scene being captured (such as whether indoors or outdoors, daytime or nighttime, etc.). In some other example implementations, the threshold is fixed (such as 50 percent). The threshold may be determined in any suitable way, and the present disclosure should not be limited to a specific threshold.

Referring back to FIG. 3 for performing color balancing for a first image, the device 200 may estimate a color temperature (such as a CCT) for a second image (306) in response to determining that a second image is to be used in color balancing a first image (302). For example, the device 200 may analyze the pixel colors for the first image to estimate an overall color temperature of the light sources illuminating the scene in the first image. In some example implementations, the device 200 may perform an AWB operation in determining a color temperature. For example, the device 200 may divide an image into a plurality of portions, determine the R/G and the B/G for each portion, and use the distribution of the R/G to B/G for the portions to determine a color temperature for the image.

Referring back to FIG. 4 regarding estimating a color temperature, in some example implementations, the device 200 may observe or determine a location of a cluster (such as cluster 410) to determine a color temperature. Incandescent lighting (such as having a color temperature of 2400 K) may cause measurements for portions of the image to be located in the graph 406 near cluster 410. Fluorescent lighting (such as having a color temperature of 4100 K) may cause measurements for portions of the image to be located in the graph 406 towards the B/G axis instead of the R/G axis. In this manner, if the device 200 determines that a cluster of portions (such as having a number of points greater than a threshold within a range of R/G to B/G) is near a location for a type of lighting, the device 200 may determine the color temperature for the image to be near or approximate to the color temperature for the lighting (such as determining the color temperature for the image 402 to be near 2400 K). For example, with the R/G versus B/G portions for the wall inferring incandescent lighting exists, the device 200 may estimate that the color temperature is closer to incandescent lighting (2400 K) than fluorescent lighting (4100 K).

Referring back to the example operation 300 in FIG. 3, the device 200 may determine, based on the color temperature for the second image, a color balance for a first image (308). For example, if the color temperature for the first image indicates a blue tinting (such as 4100 K or greater), the device 200 may determine a color balance to reduce blue colors in the second image. The color balance may be, e.g., a gain to be applied to the color or chrominance values of each pixel in the image during processing.

In some example implementations, the device 200 may assume the estimated color temperature for the second image is the color temperature for the first image to be color balanced. In some other example implementations, the device 200 may estimate a first color temperature for the first image and may estimate a second color temperature for the second image (such as during AWB for each image). The device 200 may then combine the two color temperatures to determine a final color temperature to be used for color balancing the first image. For example, the device 200 may average (such as a simple average or weighted average) the color temperatures. If using a weighted average, the weights may correspond to the size of the portion of the second image that is one color. For example, a larger portion of an image that is a single color may cause larger inaccuracies in estimating a color temperature for the image. As a result, the color temperature weight for averaging may decrease as the portion of the image that is a single color increases. Other ways to weight the color temperatures or for averaging may be performed, and the disclosure should not be limited to the provided examples.

After the device 200 determines a color balance for the first image (308), the device 200 may process the first image to generate a final image using the determined color balance (310). Referring again to the example of determining a color balance to reduce blue tinting, the device 200 may apply the color balance to each pixel in the first image to reduce the blue colors in the second image during processing. If a combination of multiple color temperatures is used, the device 200 may use the color temperature for the second image in determining the final color temperature for color balancing the first image.

In using another image for color balancing an image, a first image and a second image may be captured by the same camera (such as the first camera 201 or the second camera 202). For example, a first image may be captured, the device may be moved so that the camera that captured the first image has a different orientation, and a second image may be captured. In this manner, the second image may include different portions of a scene so that less than a threshold portion of the image is one color. In some other example implementations, the first image may be captured by one camera (such as the first camera 201), and the second image may be captured by another camera (such as the second camera 202). The first camera 201 may have a different field of view than the second camera 202. In this manner, the second image from the second camera 202 includes a different portion of the scene than the first image from the first camera 201. The first image may have a portion greater than a threshold size that is one color while the second image does not have a portion greater than the threshold size that is one color.

If a different camera is to be used for capturing a different image to be used in color balancing an image, the camera may be in a low power mode and activated based on determining that a threshold portion of an image being a single color. For example, the first camera 201 of the device 200 may be active to capture images while the second camera 202 of the device 200 may be in a low power mode. When the device 200 determines that an image from the first camera 201 includes a portion greater than a threshold that is a single color, the device 200 may remove the second camera 202 from the low power mode to capture one or more images for color balancing an image from the first camera 201. In some other example implementations, both the first camera 201 and the second camera 202 may capture both images concurrently, and the device 200 may determine to use one or more captures from the second camera 202 to color balance an image from the first camera 201. In some further example implementations, a previously captured or stored image of the scene may be used for color balancing an image from the first camera 201.

In some example implementations, the first camera 201 may be a rear facing camera, and the second camera 202 may be a front facing camera. The front facing camera for a device 200 (such as a smartphone or tablet) may be oriented toward a user. If an image captured by a front facing camera is to be used in color balancing an image captured by a rear facing camera, the image from the front facing camera may include the user or a portion of the user. Inclusion of the user in the image may affect estimation of the color temperature of the image. For example, if a flash or LED light source is used to illuminate the user for the front facing camera, the light reflecting from the user may adversely affect the colors in the scene and thus may affect the estimated color temperature. In another example, the color of the user's clothes may adversely affect estimation of a color temperature if the clothes are one color and occupy a large portion of the image (such as greater than a threshold portion of the image).

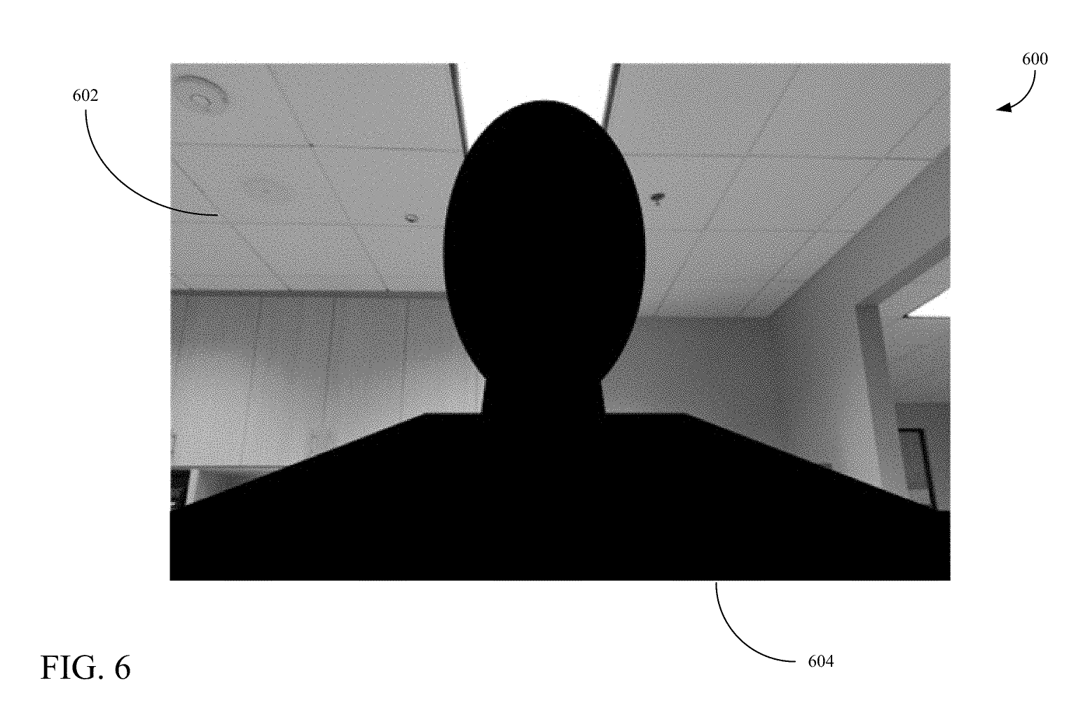

FIG. 6 is a depiction of an example image 600 from a front facing camera corresponding to the example processed image 102 in FIG. 1A captured by a rear facing camera. As shown, fluorescent lighting (with a color temperature of 4100 K) is illuminating the scene. The background 602 (such as the ceiling, walls, and objects further from the device than the user 604) may be used to determine a color temperature to be used for color balancing another image. However, the user 604 blocks portions of the background 602 in the image 600. If the image 600 is divided into portions, and the R/G and the B/G are determined for each portion in determining a color temperature, the portions including the user may skew the color temperature (as compared to if the user is not in the image 600).

In some example implementations, the background for two cameras may be assumed to be the same. In this manner, the device 200 may determine to use only portions of an image where the objects in the scene are at least a threshold distance from the device 200. For example, before determining a color temperature for the image 600, the device 200 may exclude portions of the image 600 including the user 604 (which is closer than the background 602 to the device 200) before determining a color temperature for the image. In some example implementations, a camera may capture two images in succession and compare the two images to determine depths of objects in the scene being captured. For example, if a front facing camera captures an image to determine a color temperature, the camera may capture a reference image with a different camera orientation. However, the user may appear in both images (with the user moving with the camera), and the user may appear more static than the background between the images.

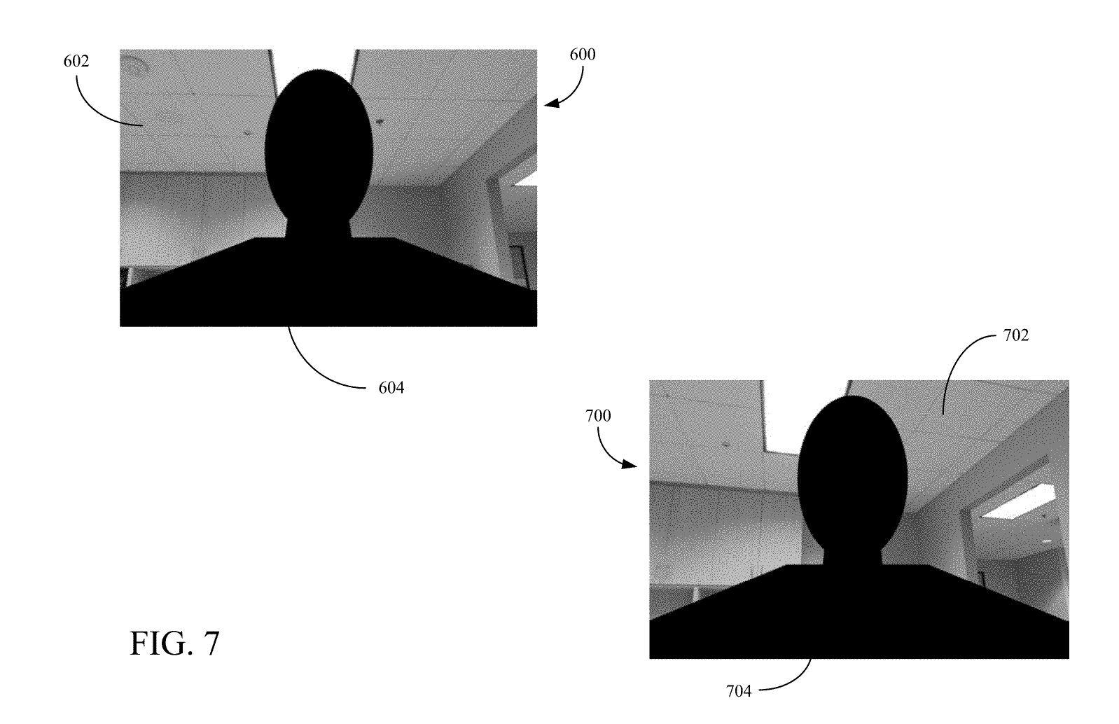

FIG. 7 is a depiction of an example reference image 700 for the example image 600 (which is to be used in determining a color temperature). The camera that captures both the image 600 and the image 700 changes orientation between captures. As a result, the background 602 and the background 702 differ. There may be differences in size and/or position between the user 604 and the user 704 in the images 600 and 700, respectively, but the difference is less pronounced than the difference between the backgrounds 602 and 702. In some example implementations, the device 200 may determine the difference in location for corresponding portions between the images, and portions with a difference less than a threshold may be excluded from being used in determining a color temperature (e.g., the excluded portions may be considered to include objects, such as a user, too close to the device 200).

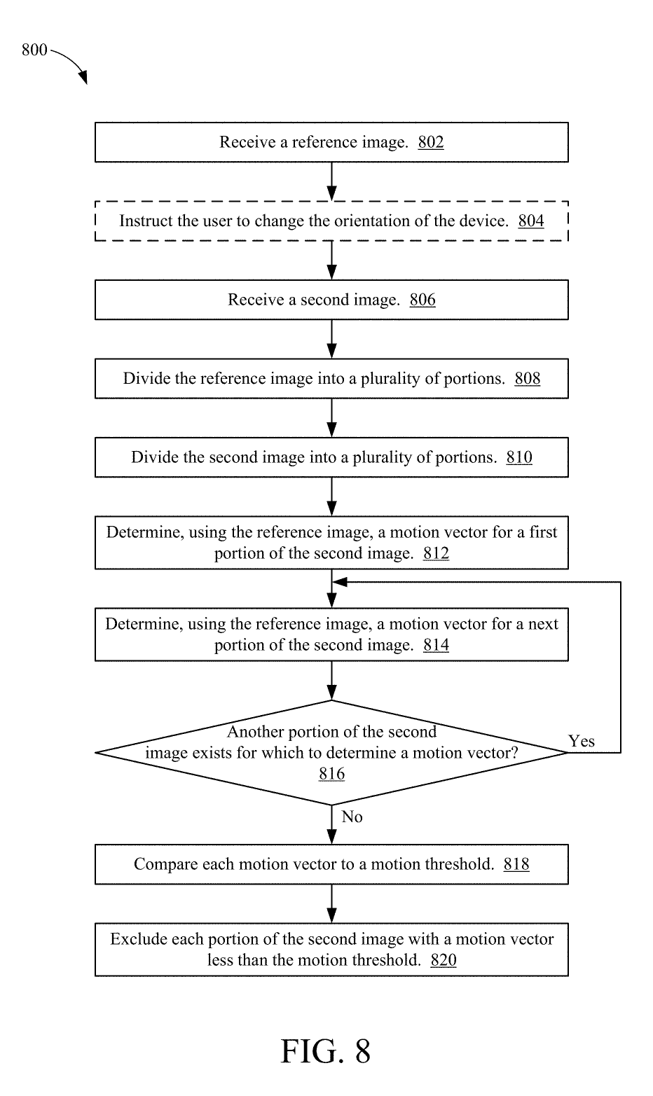

FIG. 8 is an illustrative flow chart depicting an example operation 800 for excluding one or more portions of an image before determining a color temperature for the image. Beginning at 802, the device 200 may receive a reference image. For example, the second camera 202 (which may be a front facing camera) may capture the reference image (such as example image 700 in FIG. 7) and provide the image to the device 200 (such as to the camera controller 210). After receiving the reference image (802), the device 200 may optionally instruct the user to change the orientation of the device (804) and receive a second image (806) after changing orientation. In some other example implementations, the device 200 may receive the second image (806) without instructing the user to change the orientation of the device 200 (804). In one example, the change in orientation from involuntary user movements may be sufficient. In another example, the background may move with reorienting the camera (such as capturing images in a moving vehicle or while the user is travelling).

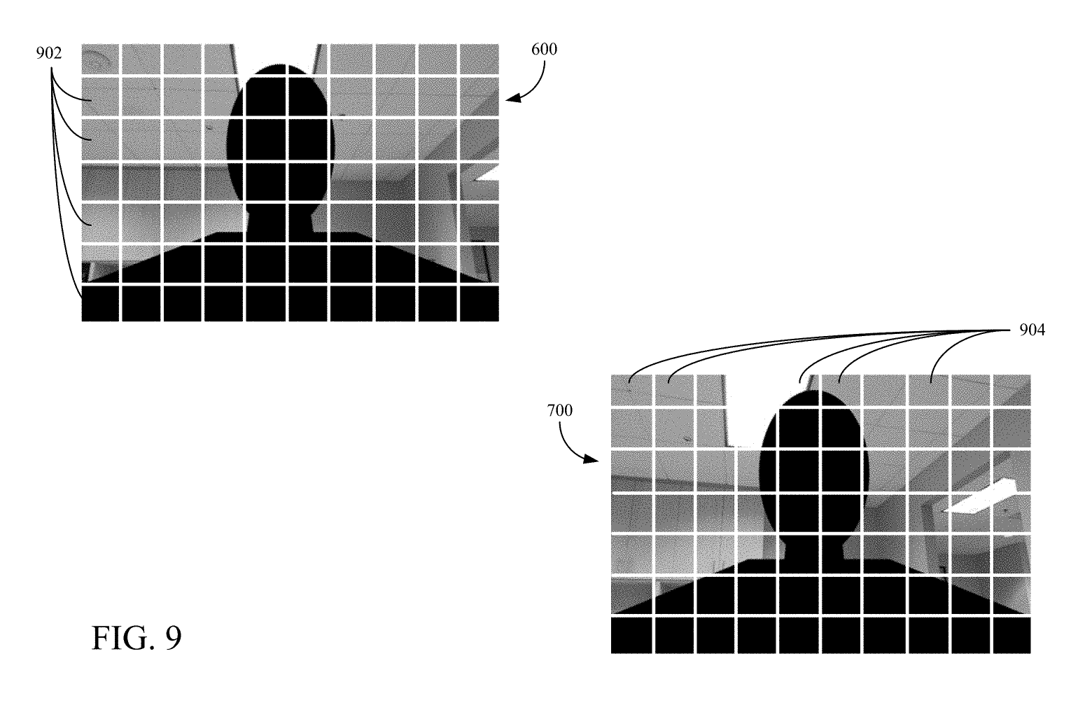

The device 200 may divide the reference image into a plurality of portions (808), and may divide the second image into a plurality of portions (810). In some example implementations, the portions may be arranged in a lattice, and the portions may be of equal size among the portions for both images. FIG. 9 is a depiction of the example reference image 700 in FIG. 7 and the example image 600 in FIG. 6 divided into a plurality of portions. The example image 600 is divided into a plurality of portions 902, and the example image 700 is divided into a plurality of portions 904. The images may be divided into any number of portions, and the portions may be of any size or shape. The present disclosure should not be limited to a specific example of dividing an image into portions.

Referring back to FIG. 8, the device 200 may determine a motion vector for each portion of the second image. For example, the device 200 may determine, using the reference image, a motion vector for a first portion of the second image (812). The device 200 may also determine, using the reference image, a motion vector for a next portion of the second image (814). If another portion of the second image exists for which to determine a motion vector (816), the device 200 may determine the motion vector for the next portion of the second image (reverting to 814).

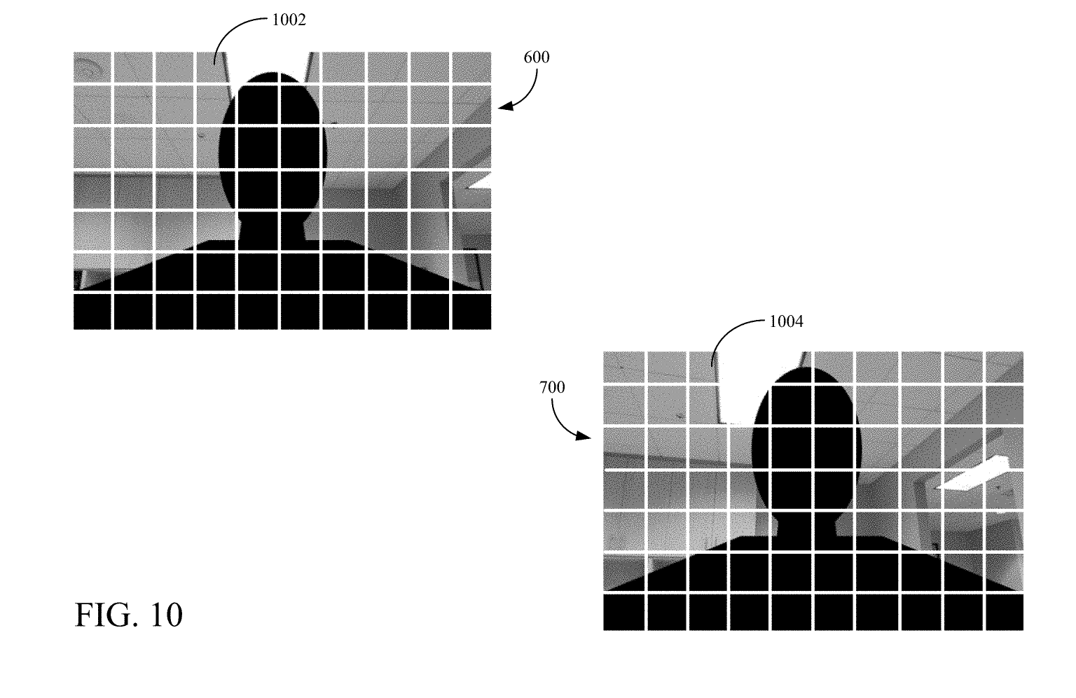

The motion vector may be a measurement of the difference in location of a portion in the second image from a corresponding portion in the reference image. Corresponding portions between the second image and the reference image may include approximately the same or similar scene contents. FIG. 10 is a depiction of the example image 600 and the example reference image 700 divided into portions (FIG. 9) with corresponding portions 1002 and 1004 between the example images. The portion 1002 and the portion 1004 approximately include the same portions of the scene (such as a same piece of the ceiling and a same piece of the fluorescent light). The motion vector for portion 1002 may be the difference in location in each image between portion 1002 and portion 1004 (e.g., portion 1004 is further left than portion 1002 in the images 700 and 600, respectively).

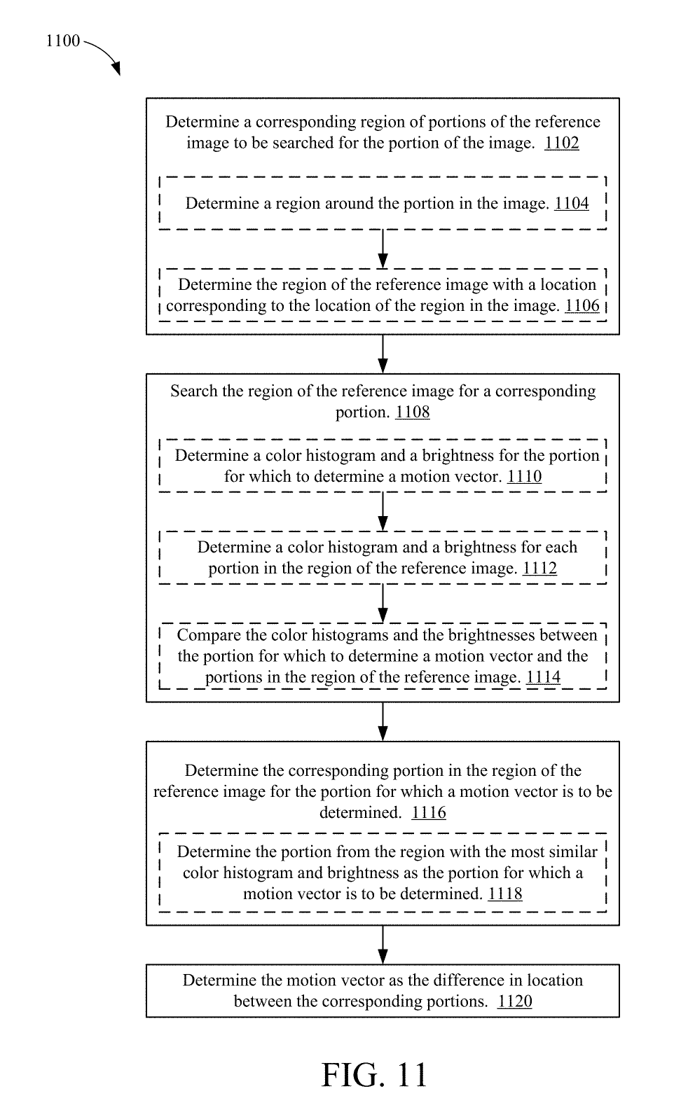

FIG. 11 is an illustrative flow chart depicting an example operation 1100 for determining a motion vector for a portion of an image. Beginning at 1102, the device 200 may determine a region of portions of the reference image corresponding to the portion of the image for which to determine a motion vector. The corresponding region of portions of the reference image is to be searched for finding a portion corresponding to the portion for which a motion vector is being determined. In some example implementations, the device 200 may determine a region around the portion in the image (1104), and then determine the region of the reference image to correspond to the location of the region in the image including the portion for which a motion vector is to be determined (1106).

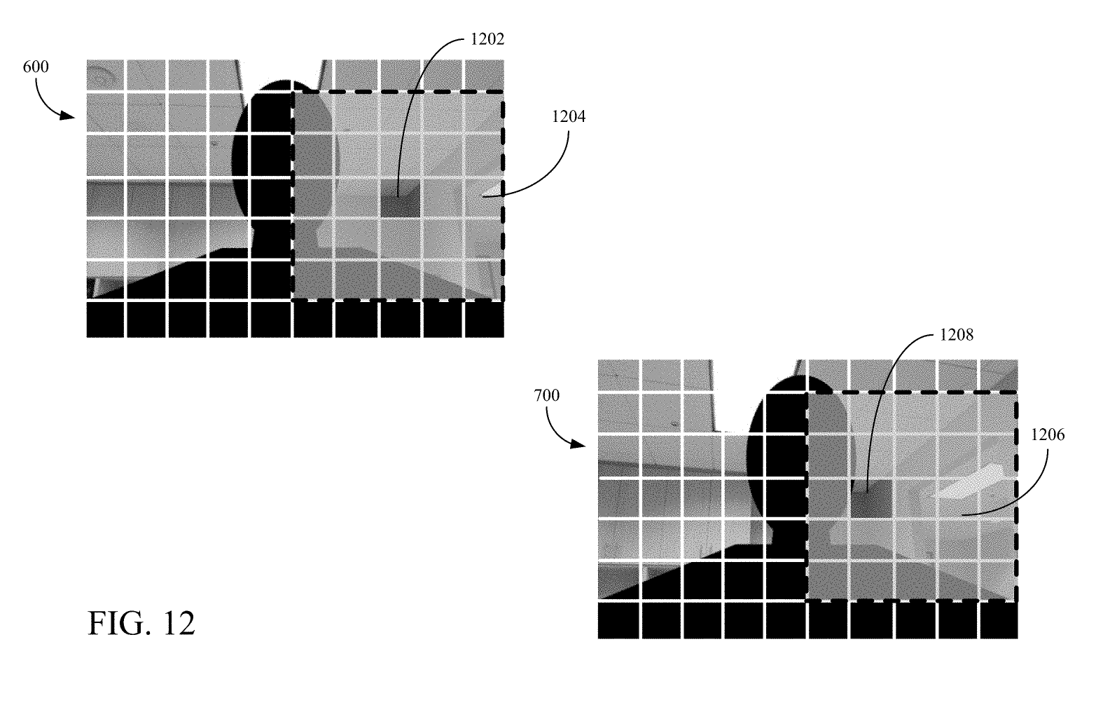

FIG. 12 is a depiction of the example reference image 700 and the example image 600 divided into portions (FIG. 9) in determining a corresponding region in the reference image 700 for portion 1202 in the image 600. The example region 1204 around the portion 1202 may be determined by the device 200. For example, the device 200 may determine a region of a defined size (such as a defined number of portions) and orientation (such as centered at portion 1202). The region 1204 may be fixed or adjustable. For example, when first determining a motion vector, the region 1204 may be larger. Neighboring portions in image 600 may have similar motion vectors. In this manner, the determined motion vector for portion 1202 may be used to determine the size and/or location of the region for a neighboring portion for which a motion vector is to be determined. In another example, the region is fixed for all determinations. In a further example, the size and/or location of the region may be based on the color, brightness, or other measurements of the image. The region may be of any size, shape, location, and/or determined by other suitable means (such as using the entire reference image, half of the reference image, etc.), and the present disclosure should not be limited to a specific size, shape, or location of a region.

The device 200 may determine region 1206 of the reference image 700 to be searched, as the location of the region 1206 in the reference image 700 is the same as the location of the region 1204 in the image 600. In this manner, the device 200 may determine if a portion in the region 1206 corresponds to the portion 1202 (such as portion 1208 in the region 1206).

Referring back to FIG. 11, the device may search the determined region of the reference image for a corresponding portion 1108. In some example implementations of searching the region, the device 200 may compare the color histograms and brightness for the portions in the region to determine a portion in the reference image with a similar color histogram and brightness as the portion for which a motion vector is to be determined. For example, the device 200 may optionally determine a color histogram and a brightness for the portion for which to determine a motion vector (1110). In some examples, the color histogram may include representations of the red color, blue color, and green color in an RGB space for pixels in the portion. In some other examples, the color histogram may include representations of the chrominance UV in a Y′UV space for pixels in the portion. The color histogram may be any representation of the colors of the pixels in the portion of an image, and the present disclosure should not be limited to a specific example of a color histogram or representation of the colors. The brightness of a portion may be the overall brightness of the pixels in the portion. For example, the brightness may be an overall luminance, luma or other measurement of brightness. The overall brightness might be an average brightness, median brightness, sum of brightness across the pixels in the portion, or other suitable determination of brightness for the portion, and the present disclosure should not be limited to a specific example of brightness.

The device 200 may also optionally determine a color histogram and a brightness for each portion in the determined region of the reference image (1112). The device 200 may then optionally compare the color histogram and brightness of each portion in the determined region in the reference image to the color histogram and the brightness of the portion for which a motion vector is to be determined (1114).

As a result of searching the region in the reference image, the device 200 may determine the corresponding portion in the region of the reference image for the portion for which a motion vector is to be determined (1116). Referring back to FIG. 12, the device 200 may determine a motion vector for the portion 1202 of the image 600. In searching the region 1206 of reference image 700, the device 200 may determine that portion 1208 in the region 1206 corresponds to portion 1202.

Referring back to FIG. 11, in some examples of determining the corresponding portion, the device 200 may optionally determine the corresponding portion from the region in the reference image with the most similar color histogram and brightness (1118). For example, referring back to FIG. 12, the device 200 may compare the color histogram and the brightness of the portion 1202 to the color histogram and the brightness for each portion in the region 1206 (including portion 1208). Any suitable measurement of the differences between color histograms and between brightness may be used to determine which color histogram and brightness is most similar. Additionally or alternatively, the brightness and the color histogram may be given different weights in affecting the determination. Further, the weights may be adjustable for different scenarios. For example, for a scene with multiple light sources or indoor lighting, brightness may be given more importance in relation to the color histograms than for a scene in direct sunlight or less variation in lighting. The comparison may be performed in any way, and the present disclosure should not be limited to a specific example.

In some example implementations, the device 200 may determine that none of the portions in the region of the reference image correspond to the portion for which a motion vector is to be determined. For example, the scene at an edge of an image may not appear in the reference image as a result of reorienting the camera. If the color histogram and the brightness for portions are compared, the device 200 may determine that the color histogram and the brightness for each portion in the region of the reference image are not within a difference threshold from the color histogram and the brightness for the portion for which a motion vector is to be determined. For example, if the brightness and the color histogram for each portion in the region 1206 is not within a difference threshold from the brightness and the color histogram for the portion 1202, the device 200 may determine that no portion of the reference image 700 corresponds to the portion 1202. In some other example implementations, if the device 200 determines that a corresponding portion in the region of the reference image does not exist, the device 200 may increase the size of the region to search portions not previously included in the region. Other suitable ways of determining a corresponding portion may be performed, and the present disclosure should not be limited to a specific example of determining corresponding portions.

Referring back to FIG. 11, the device 200 may determine the motion vector as the difference in location between the corresponding portions (1120). For example, the motion vector may be a Euclidian distance (measured in pixels, portions, or other suitable unit of measurement) between the locations of the portions in their respective images (such as the distance between the location of portion 1202 in image 600 and the location of portion 1208 in reference image 700).

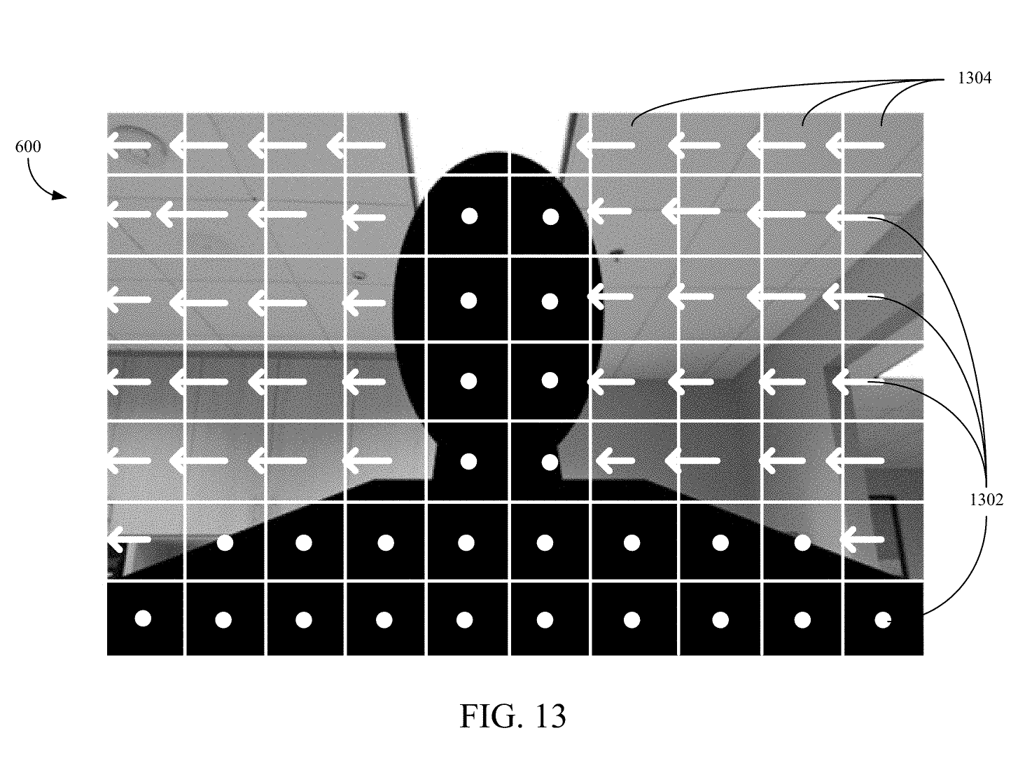

FIG. 13 is a depiction of the image 600 with the determined motion vectors 1302 illustrated (as arrows) for each portion 1304. Circles without arrows indicate a motion vector with a magnitude of zero. As shown, the portions including the user (which moves with the camera movement between captures) may have a motion vector with a magnitude of zero. In some example implementations, the motion vector for portions at the edge of the image may have a magnitude of zero if no corresponding portions from the reference image are determined (such as the scene in the edge portions not being in the reference image as a result of reorienting the camera).

Referring back to FIG. 8, after a motion vector is determined for each portion in the image for which a color temperature is to be determined, the device 200 may compare each motion vector to a motion threshold (818). The motion threshold may be adjustable based on, e.g., the size of the largest portion of the scene that is one color, the type of scene, or another suitable measure. Alternatively, the motion threshold may be fixed. In some example implementations, the motion threshold may be a vector magnitude. For example, each motion vector magnitude may be compared to a magnitude threshold. In some other example implementations, the motion threshold may include a direction. For example, if the motion vectors indicate a movement of the camera's yaw from left to right between images, in addition to comparing the magnitude of a motion vector to a threshold, the device 200 may compare the direction of the motion vector to an overall direction for the motion vectors (such as indicating a left to right movement of the camera's yaw).

Proceeding to 820 in FIG. 8, the device 200 may exclude each portion of the second image with a motion vector less than the motion threshold. The excluded portions may not be used in determining a color temperature for the second image. In some example implementations, if the magnitude is less than a threshold magnitude, the corresponding portion may be excluded. In some other example implementations, if the magnitude is less than a threshold magnitude or the difference between a direction of the motion vector and an overall direction of the motion vectors is greater than a threshold, the corresponding portion may be excluded.

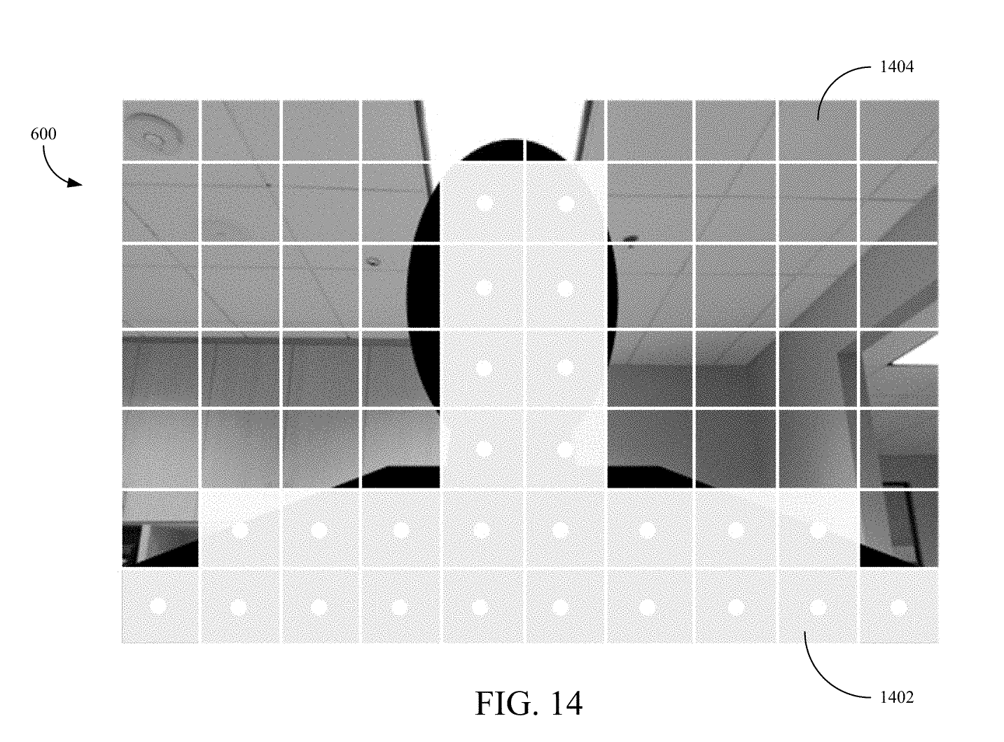

FIG. 14 is a depiction of the example image 600 with portions 1402 excluded from being used in determining a color temperature. In comparing the images in FIG. 13 and in FIG. 14, the portions with motion vectors with zero magnitude are part of excluded portions 1402. The remaining portions 1404 have motion vectors greater than the motion threshold and are thus not excluded. The remaining portions 1404 (not excluded) may be used in determining the color temperature for the image 600 (such as previously described). Once the color temperature is determined for the second image, the device may use the determined color temperature in color balancing a first image (such as previously described).

While motion vectors are described in determining which portions of an image to exclude from determining a color temperature, any suitable way of determining which portions of the image to exclude may be performed. In one example, the device 200 may use object or facial recognition to determine that a person or user is in the image. The device 200 may then determine to exclude the portions of the image including the identified person or user. Object recognition may also be used to determine that an object does not move more than a threshold distance between images. The portions of the image including objects that move less than a threshold between images may be excluded. In another example, the device 200 may determine threshold changes in brightness for portions of an image. For example, the luminance from a window or other light source in an image may be more than a threshold greater than the luminance of the remainder of the background or a median luminance. Further, a flash illuminating a user may cause the brightness in the portions of the image with the user to be greater than the brightness of the background. The device 200 may therefore determine to exclude such portions of the image. In a further example, the color temperature of a portion of the image from a front facing camera may be more than a threshold different than a color temperature of the image from a rear facing camera, but the remainder of the image from the front facing camera may have a color temperature within a threshold difference from the color temperature of the image from the rear facing camera. A threshold difference in color temperature for a portion of the image from the front facing camera may indicate the presence of a user or object blocking the background in the image. In this manner, the device 200 may exclude the portion of the image from the front facing camera more than a threshold difference in color temperature from the color temperature of the image from the rear facing camera. In another example, a color histogram and brightness for each portion at the same location in the reference image and the second image may be compared. If the difference between the measurements is less than a threshold, the device 200 may determine to exclude the portion of the second image. Other measurements may also be used, such as depth, focal length, etc. The present disclosure should not be limited to specific examples for excluding portions of the second image before determining a color temperature. Further, the device 200 may not exclude any portion, and all portions of the image may be used in determining the color temperature.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium (such as the memory 206 in the example device 200 of FIG. 2) comprising instructions 208 that, when executed by the processor 204 (or the camera controller 210 or the image signal processor 212), cause the device 200 to perform one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as the processor 204 or the image signal processor 212 in the example device 200 of FIG. 2. Such processor(s) may include but are not limited to one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

While the present disclosure shows illustrative aspects, it should be noted that various changes and modifications could be made herein without departing from the scope of the appended claims. Additionally, the functions, steps or actions of the method claims in accordance with aspects described herein need not be performed in any particular order unless expressly stated otherwise. For example, the steps of the described example operations, if performed by the device 200, the camera controller 210, the processor 204, and/or the image signal processor 212, may be performed in any order and at any frequency. Furthermore, although elements may be described or claimed in the singular, the plural is contemplated unless limitation to the singular is explicitly stated. Accordingly, the disclosure is not limited to the illustrated examples and any means for performing the functionality described herein are included in aspects of the disclosure.

What is claimed is:

1. A method for color balancing, comprising:
determining that a threshold portion of a first image is a single color;
estimating a color temperature for a second image in response to determining that the threshold portion of the first image is the single color;
determining, based on the color temperature, a color balance for the first image; and
processing the first image to generate a final image using the determined color balance.

2. The method of claim 1, further comprising receiving the second image in response to determining that the threshold portion of the first image is the single color.

3. The method of claim 2, wherein the first image is captured by a first camera and the second image is captured by a second camera.

4. The method of claim 3, further comprising:
capturing the first image in a first direction from a device; and
capturing the second image in a second direction from the device, the second direction different from the first direction.

5. The method of claim 4, wherein:
capturing the first image comprises capturing the first image by a rear facing camera of the device; and
capturing the second image comprises capturing the second image by a front facing camera of the device.

6. The method of claim 3, wherein estimating the color temperature comprises:
receiving a reference image captured by the second camera;
dividing the second image into a plurality of regions; and
for each of the plurality of regions:
comparing the reference image to the second image; and
determining a motion vector based on the comparison.

7. The method of claim 6, wherein estimating the color temperature further comprises:
comparing the motion vector for a region to a motion threshold; and
excluding the region from being used in estimating the color temperature based on the motion vector for the region being less than the motion threshold.

8. The method of claim 7, wherein determining the motion vector for a region in the second image comprises:
determining a brightness for the region;
determining a color comparison metric for the region;
comparing the brightness and the color comparison metric for the region to brightness and color comparison metrics for regions in a portion of the reference image corresponding to a location of the region in the second image;
determining a region in the portion of the reference image corresponding to the region in the second image based on the comparison; and
determining as the motion vector a difference in location between the region in the reference image and the region in the second image.

9. A device configured to color balance an image, comprising:
one or more processors; and
a memory coupled to the one or more processors and including instructions that, when executed by the one or more processors, cause the device to perform operations comprising:
determining that a threshold portion of a first image is a single color;
estimating a color temperature for a second image in response to determining that the threshold portion of the first image is the single color;
determining, based on the color temperature, a color balance for the first image; and
processing the first image to generate a final image using the determined color balance.

10. The device of claim 9, wherein execution of the instructions causes the device to perform operations further comprising:
receiving the first image in response to determining that the threshold portion of the second image is the single color.

11. The device of claim 10, further comprising:
a first camera to capture the first image; and
a second camera to capture the second image.

12. The device of claim 11, wherein:
the first camera is directed in a first direction from the device; and
the second camera is directed in a second direction from the device, the second direction different from the first direction.

13. The device of claim 12, wherein:
the first camera is a rear facing camera; and
the second camera is a front facing camera.

14. The device of claim 11, wherein execution of the instructions in estimating the color temperature causes the device to perform operations comprising:
receiving a reference image captured by the second camera;
dividing the second image into a plurality of regions; and
for each of the plurality of regions:
comparing the reference image to the second image; and
determining a motion vector based on the comparison.

15. The device of claim 14, wherein execution of the instructions in estimating the color temperature causes the device to perform operations further comprising:
comparing the motion vector for a region to a motion threshold; and
excluding the region from being used in estimating the color temperature based on the motion vector for the region being less than the motion threshold.

16. The device of claim 15, wherein execution of the instructions in determining the motion vector for a region in the second image causes the device to perform operations comprising:
determining a brightness for the region;
determining a color comparison metric for the region;
comparing the brightness and the color comparison metric for the region to brightness and color comparison metrics for regions in a portion of the reference image corresponding to a location of the region in the second image;
determining a region in the portion of the reference image corresponding to the region in the second image based on the comparison; and
determining as the motion vector a difference in location between the region in the reference image and the region in the second image.

17. A non-transitory computer-readable medium storing one or more programs containing instructions that, when executed by one or more processors of a device, cause the device to perform operations comprising:
determining that a threshold portion of a first image is a single color;
estimating a color temperature for a second image in response to determining that the threshold portion of the first image is the single color;
determining, based on the color temperature, a color balance for the first image; and
processing the first image to generate a final image using the determined color balance.

18. The non-transitory computer-readable medium of claim 17, wherein execution of the instructions causes the device to perform operations further comprising receiving the second image in response to determining that the threshold portion of the first image is the single color.

19. The non-transitory computer-readable medium of claim 18, wherein the first image is captured by a first camera in a first direction from the device and the second image is captured by a second camera in a second direction from the device, the second direction different from the first direction.

20. The non-transitory computer-readable medium of claim 19, wherein execution of the instructions causes the device to perform operations further comprising:
capturing the first image by a rear facing camera; and
capturing the second image by a front facing camera.

21. The non-transitory computer-readable medium of claim 19, wherein execution of the instructions for estimating the color temperature causes the device to perform operations comprising:
receiving a reference image captured by the second camera;
dividing the second image into a plurality of regions; and
for each of the plurality of regions:
comparing the reference image to the second image; and
determining a motion vector based on the comparison.

22. The non-transitory computer-readable medium of claim 21, wherein execution of the instructions for estimating the color temperature causes the device to perform operations further comprising:
comparing the motion vector for a region to a motion threshold; and
excluding the region from being used in estimating the color temperature based on the motion vector for the region being less than the motion threshold.

23. The non-transitory computer-readable medium of claim 22, wherein execution of the instructions for determining the motion vector for a region in the second image causes the device to perform operations comprising:
determining a brightness for the region;
determining a color comparison metric for the region;
comparing the brightness and the color comparison metric for the region to brightness and color comparison metrics for regions in a portion of the reference image corresponding to a location of the region in the second image;
determining a region in the portion of the reference image corresponding to the region in the second image based on the comparison; and
determining as the motion vector a difference in location between the region in the reference image and the region in the second image.

24. A device configured to perform color balancing, comprising:
means for determining that a threshold portion of a first image is a single color;
means for estimating a color temperature for a second image in response to determining that the threshold portion of the first image is the single color;
means for determining, based on the color temperature, a color balance for a first image; and
means for processing the first image to generate a final image using the determined color balance.

25. The device of claim 24, further comprising means for receiving the first image in response to determining that the threshold portion of the second image is the single color.

26. The device of claim 25, further comprising:
means for capturing the first image in a first direction from the device; and
means for capturing the second image in a second direction from the device, the second direction different from the first direction.

27. The device of claim 26, wherein the means for estimating the color temperature comprises:
means for receiving a reference image captured in the second direction from the device;
means for dividing the second image into a plurality of regions; and
means for, for each of the plurality of regions:
comparing the reference image to the second image; and
determining a motion vector based on the comparison.

28. The device of claim 27, wherein the means for estimating the color temperature further comprises:
means for comparing the motion vector for a region to a motion threshold; and
means for excluding the region from being used in estimating the color temperature based on the motion vector for the region being less than the motion threshold.

29. The device of claim 28, wherein the means for determining the motion vector for a region in the first image comprises:
means for determining a brightness for the region;
means for determining a color comparison metric for the region;
means for comparing the brightness and the color comparison metric for the region to brightness and color comparison metrics for regions in a portion of the reference image corresponding to a location of the region in the second image;
means for determining a region in the portion of the reference image corresponding to the region in the second image based on the comparison; and
means for determining as the motion vector a difference in location between the region in the reference image and the region in the second image.

30. The device of claim 26, wherein:
the first direction originates from a back of the device; and
the second direction originates from a front of the device.
